(19) United States
(12) Patent Application Publication
(10) Pub. No.: US 2021/0102671 A1
(43) Pub. Date: Apr. 8, 2021

(54) LOW VOLTAGE, DIGITALLY ADDRESSABLE, MODULAR LIGHTING SYSTEMS

(71) Applicant: WeWork Companies Inc., New York, NY (US)

(72) Inventors: B. Star Davis, New York, NY (US); Michael P. Day, New York, NY (US)

(21) Appl. No.: 17/027,581

(22) Filed: Sep. 21, 2020

Related U.S. Application Data
(60) Provisional application No. 62/902,858, filed on Sep. 19, 2019.

(51) Int. Cl. F21S 2/00; F21V 23/04; F21V 29/70; F21V 3/00; F21V 17/12; F21V 23/06

(52) U.S. Cl. CPC F21S 2/005; F21V 23/0435; F21V 29/70; F21Y 2115/10; F21V 17/12; F21V 23/06; F21V 3/00

(57) ABSTRACT

A lighting system including a low voltage power box configured to supply power to multiple modular light fixtures, one or more low voltage cables, and a modular light fixture connected to the low voltage power box via the one or more low voltage cables. The low voltage power box can comprise a wireless control component operative to receive signals from a wireless device and control the modular light fixture according to the received signals.

### CROSS-REFERENCE TO RELATED APPLICATION

This application claims the benefit of and priority to U.S. Provisional Patent Application No. 62/902,858, filed Sep. 19, 2019, the disclosure of which is incorporated herein by reference in its entirety.

### BACKGROUND

Many workers in service or other industries typically use or need an office in which to work, which often takes the form of thousands of square feet of office space leased or owned by the worker's employer. Some workers are self-employed or work for small companies that may have a more difficult time finding an acceptable space in which to work. These self-employed or small company workers—as well as workers for large businesses—have turned to coworking arrangements.

Coworking is a self-directed, collaborative, and flexible work style, often based around a common interest, such as geographic location, shared social values, etc. Coworking typically employs a shared workplace and independent activities among individuals working within the workplace. Unlike a typical office, coworking often allows workers from different organizations to share resources such as conference rooms, break rooms, receptionists, IT professionals, telecommunications resources, etc. Coworking workers are relieved of the effort of finding, renting, outfitting, supplying, and managing their own space.

Coworking arrangements are attractive to work-at-home professionals, independent contractors, independent scientists, and people who travel frequently—typically workers who would otherwise end up working in relative isolation (though coworking is in no way limited to such workers). Coworkers can enjoy a social gathering of a group of people who are still working independently, but who may share certain values and who are interested in the synergy that can happen from working with people who value working in the same place alongside each other. Coworking offers a solution to the problem of isolation that many freelancers experience while working at home, while at the same time letting them escape the distractions of home. Moreover, some larger businesses see the value in offering coworking arrangements for some of their employees who can enjoy the same benefits noted above, even if a large number of them represent a majority of other workers sharing a common workspace.

### BRIEF DESCRIPTION OF THE DRAWINGS

FIG. 1 is a partial schematic, partial block diagram of a coworking space.

FIG. 2 is a block diagram of a representative mobile device that can display various GUI screens.

FIG. 3A is a diagram illustrating an example light module in accordance with embodiments of the disclosed technology.

FIGS. 3B to 3F are diagrams illustrating alternative light modules in accordance with embodiments of the disclosed technology.

FIG. 4 is a block diagram illustrating example components of a low voltage lighting system in accordance with embodiments of the disclosed technology.

FIGS. 5A to 5B are diagrams illustrating example configurations of light modules within a low voltage lighting system in accordance with embodiments of the disclosed technology.

FIG. 6 is a block diagram illustrating low voltage equipment of the lighting system in accordance with embodiments of the disclosed technology.

FIGS. 7A to 7D are diagrams illustrating various low voltage equipment assemblies in accordance with embodiments of the disclosed technology.

FIG. 8 is a diagram illustrating a low power cable plug for use within the lighting system in accordance with embodiments of the disclosed technology.

FIG. 9 is a block diagram illustrating a light module and associated mounting harness in accordance with embodiments of the disclosed technology.

FIGS. 10A to 10B are diagrams illustrating various configurations of the lighting harness in accordance with embodiments of the disclosed technology.

FIGS. 11A to 11C are diagrams illustrating example components of a light module in accordance with embodiments of the disclosed technology.

FIG. 11D is an exploded isometric view illustrating a light module in accordance with embodiments of the disclosed technology.

FIG. 11E is an exploded isometric view illustrating another light module in accordance with embodiments of the disclosed technology.

FIGS. 12A to 12B are diagrams illustrating example light module designs in accordance with embodiments of the disclosed technology.

FIG. 13 is a block diagram illustrating example components of a low voltage linear lighting system in accordance with embodiments of the disclosed technology.

FIG. 14 is a diagram illustrating various example fixture format designs for a linear lighting system in accordance with embodiments of the disclosed technology.

FIG. 15 is a diagram illustrating various applications of the linear lighting system in accordance with embodiments of the disclosed technology.

FIG. 16 is a diagram illustrating an example power connection architecture for the linear lighting system in accordance with embodiments of the disclosed technology.

FIGS. 17A to 17B are diagrams illustrating example power module configurations for the linear lighting system in accordance with embodiments of the disclosed technology.

FIG. 18 is a cross-section illustrating an example linear lighting system assembly in accordance with embodiments of the disclosed technology.

FIGS. 19A to 19B are diagrams illustrating example lighting types employing the linear lighting system in accordance with embodiments of the disclosed technology.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all suitable modifications, equivalents, combinations, and alternatives falling within the scope of the technology as defined by the appended claims.

### DETAILED DESCRIPTION

### Overview

In some embodiments, a lighting system, such as a low voltage and/or digitally addressable lighting system, is described. For example, the lighting system includes low power components that assemble to provide light within a large space (e.g., a workspace) using low voltage power sources (e.g., under 100 W) to drive light modules.

In some cases, the light modules are stand-alone modular fixtures, each of which are digitally addressable via Bluetooth (e.g., BLE) or other similar communications protocols. In other cases, the light modules are linear modules or assemblies, also digitally addressable via BLE components.

The modularity and design of the lighting system enables various benefits of utilization and deployment within a space, such as a workspace. For example, the modular light fixtures facilitate quick and efficient changes to appearances (e.g., simple or easy replacement of louvres, shades, diffusers, and so on) and are inexpensive to manufacture and maintain while providing a high quality, efficient light source within the space, among other benefits.

Further, deployment of the low voltage modular lighting systems simplifies installation and integration within a space. For example, the system can rely on fewer electrical power points (e.g., ¼ to 1/20 of the number of voltage connections for standard systems), can be installed without skilled technicians, can utilize certain wiring types (e.g., class 2, which requires fewer code regulations), and can integrate with other network and internal systems (e.g., HVAC, security, data, and so on), via its addressability and granular communicative functionality.

While the various systems and methods are described herein as applied to a co-working facility, the systems and methods are equally applicable to many other environments and are in no way limited to co-working or other workspace environments. At times, the terms “facility” and “location” are used interchangeably herein; likewise, the terms “member” and “user” are used interchangeably herein. A member or user can be an employee of a third-party company that leases space within the co-working facility or location, though a member could be a sole proprietor. A “community manager” (CM) is a representative of the organization that manages and often leases space to members within a co-working facility. The CM is effectively an office manager for all of the different companies and members within a building, floor of the building, or portion of a floor within a building. A “community team” includes not only the CM but also other representatives of the organization offering the co-working space to third parties, and can include IT professionals, janitorial employees, security personnel, etc.

In the following description, for the purposes of explanation, numerous specific details are set forth in order to provide a thorough understanding of implementations of the present technology. It will be apparent, however, to one skilled in the art that implementations of the present technology can be practiced without some of these specific details. The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

### Examples of Suitable Environments

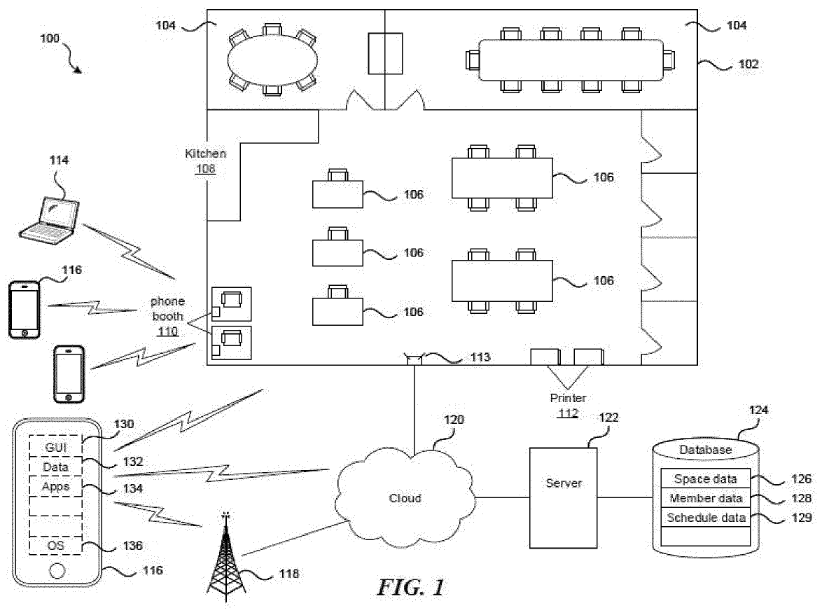

Several implementations are discussed below in more detail with reference to the figures. FIG. 1 illustrates an overview of an environment 100 in which some implementations of the disclosed technology can operate. Environment 100 includes a co-working facility 102 that includes conference rooms 104, desks 106 and a kitchen area 108. The co-working facility also includes additional resources such as phone booths 110 and printers 112, as well as IT infrastructures such as wireless routers 113 to provide wireless local networking (e.g. IEEE 802.11 WiFi networking), networked or “smart” thermostats, smart lighting, and so forth.

Members who use the co-working facility 102 typically have one or more laptop computers 114, mobile phones 116, and other data processing devices that can connect to one or more servers 122 via the wireless routers 113 or via WWAN/cellular base stations 118 and via a network or cloud 120. The server 122 is coupled to one or more databases 124. The database 124 stores data such as space data 126, member data 128 and schedule data 129. The space data 126 includes data related to physical layout and resources within the co-working facility 102. The member data 128 includes information regarding members who work within the facility 102, and can include information regarding rental or lease data, personal information, preferences, and so forth. The schedule data 129 includes information regarding scheduling of resources within the facility 102, such as the conference rooms 104, desks 106, and so forth.

As described below, each member can access or schedule resources within the facility 102 or elsewhere via one or more applications running on the laptop 114 or mobile device 116. As shown, the mobile device can include an operating system 136, one or more applications 134, application data 132 and a graphical user interface (GUI) 130.

While server 122 is displayed logically as a single server 122, the system can employ a distributed computing environment encompassing multiple computing devices located at the same or at geographically disparate physical locations. In some implementations, each server 122 can correspond to a group of servers.

Network or cloud 120 can be any network, ranging from a wired or wireless local area network (LAN), to a wired or wireless wide area network (WAN), to the Internet or some other public or private network. While the connections between the server 122 and the cloud 120 and database 124 are shown as separate connections, these connections can be any kind of local, wide area, wired, or wireless network, public or private.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

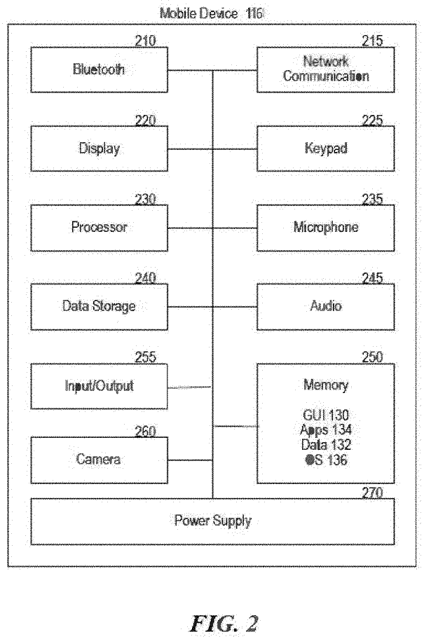

FIG. 2 is a block diagram of a representative mobile device 116 that may serve as a handset on which a member app operates in accordance with embodiments herein, though much of the same components apply equally to laptop 114. Mobile device 116 typically includes a processor 230 for executing processing instructions, a data storage medium component 240 (e.g., hard drive, flash memory, memory card, etc.), volatile memory and/or nonvolatile memory 250, a power supply 270, one or more network interfaces (e.g., Bluetooth Interface 210 or Network Communication Interface 215, which enables the mobile phone to communicate by transmitting and receiving wireless signals using licensed, semi-licensed or unlicensed spectrum over a telecommunications network), an audio interface 245, a display 220, a keypad or keyboard 225, a microphone 235, one or more cameras 260, and other input and/or output interfaces 255. The various components of the mobile device may be interconnected via a bus. The volatile and nonvolatile memories generally include storage media for storing information such as processor-readable instructions, data structures, program modules, or other data. The stored information includes instructions, which when executed by the processor 230, perform operations for performing the functions as described in detail below.

Mobile device 116 may be virtually any device for communicating over a wireless network. Such devices include application servers or mobile telephones, Personal Digital Assistants (“PDAs”), radio frequency devices, infrared devices, handheld computers, laptop computers, wearable computers, tablet computers, pagers, smart watches, integrated devices combining one or more of the preceding devices, and/or the like.

### Examples of Lighting Systems

As described herein, various lighting systems, such as lighting operated via low voltage and/or digitally addressable lighting, are described. The systems employ low voltage components as well as modular assemblies, enabling workspaces to utilize and deploy lighting fixtures in various desirable configurations, designs, and appearances, with minimal effort and high efficiency and ease.

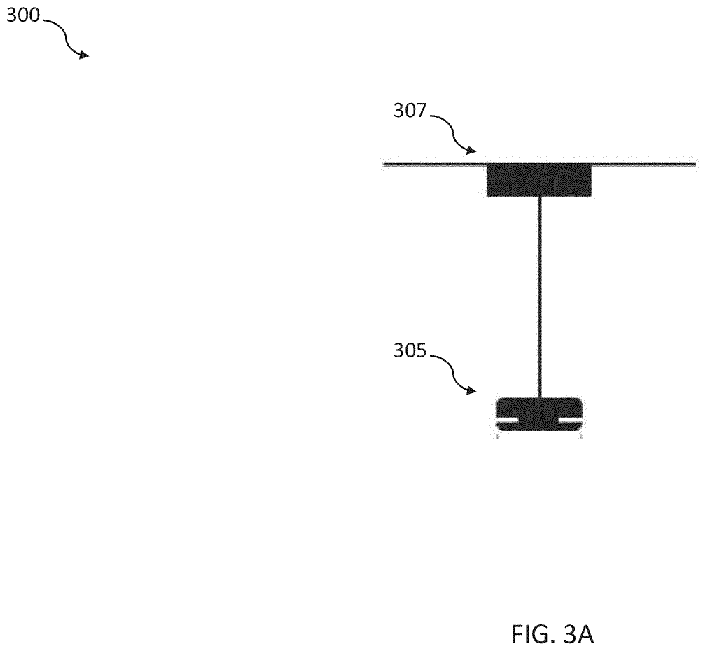

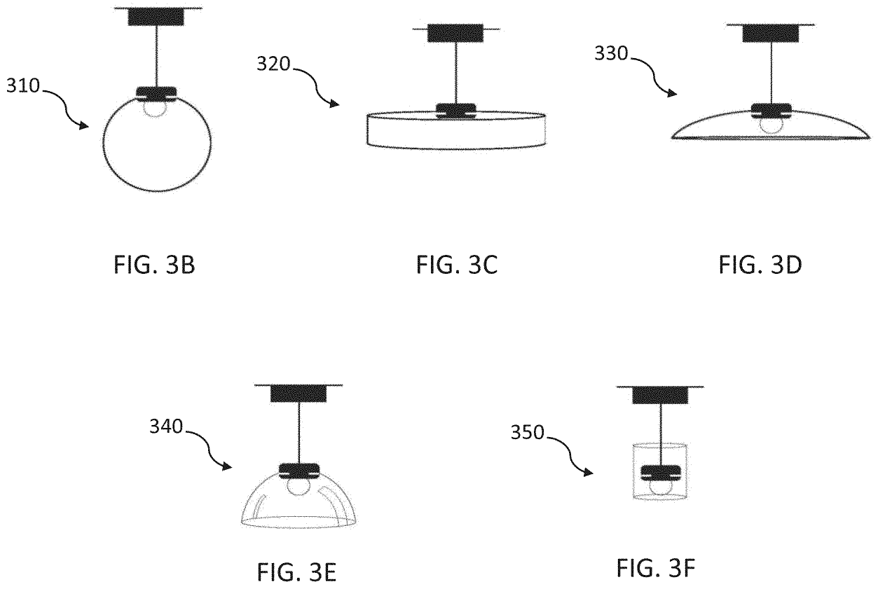

FIG. 3A is a diagram illustrating an example light module 300. The light module 300 includes a light fixture or light point (e.g., an LED light point with diffuser) 305 and a mount or mounting harness 307. Further, the light point 305 can include an internal, addressable, BLE component (or other communication components, such as wireless or near-field components). The light point 305, in some embodiments, is configured as an assembly of snap-on components and accessories (described herein).

For example, the light point 305 is a modular assembly that facilitates quick changes of a diffuser. FIGS. 3B to 3F depict various diffuser configurations (or assemblies) of the light point or module 305. FIG. 3B depicts a light module 310 having a globe diffuser. FIG. 3C depicts a light module 320 having a drum diffuser. FIG. 3D depicts a light module 330 having a shade or shade-type diffuser. FIG. 3E depicts a light module 340 having an industrial type diffuser (e.g., a metal or glass diffuser). FIG. 3F depicts a light module 350 having a cylinder or other type of diffuser. Of course, other diffuser configurations, shapes, geometries, or designs can be utilized by the light modules described herein. As described herein, the light modules 300 are powered by and/or part of a low voltage lighting system.

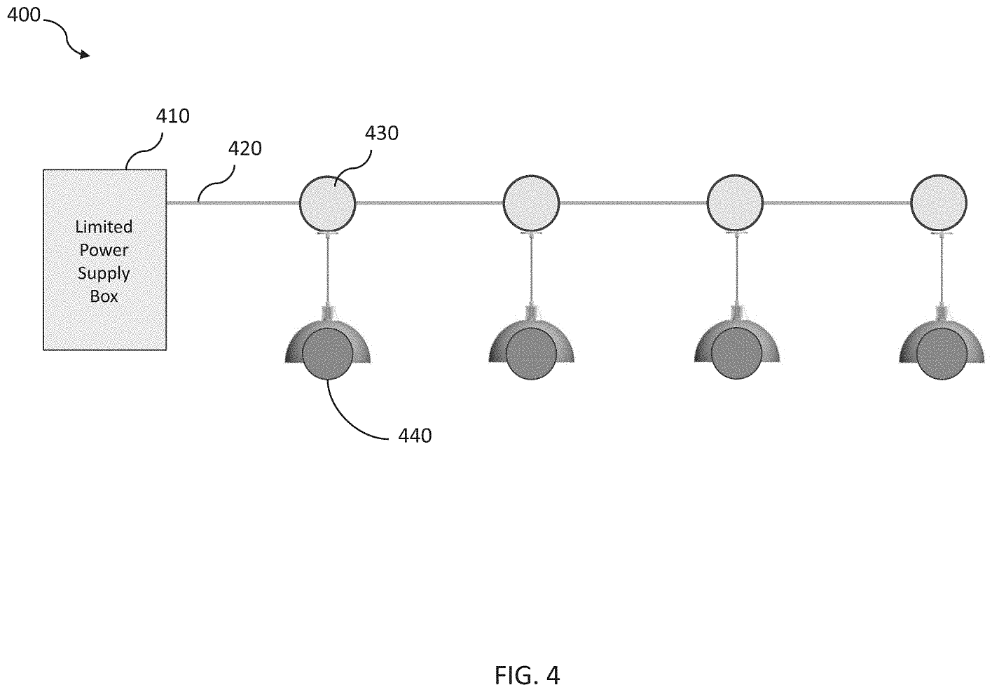

FIG. 4 is a block diagram illustrating example components of a low voltage lighting system 400 according to an embodiment of the disclosed technology. The system 400 includes a limited (or low) voltage power box 410, low voltage power cables (e.g., Cat 6 cables) 420, mounting harnesses 430 having quick connect features and/or BLE components, and light points 440.

The limited voltage power box 410 can support up to four channels of fixtures, where each channel includes up to four fixtures (as depicted, e.g., four 19 W fixtures deployed on a channel). Thus, the box 410 supports and drives up to 16 light points 440.

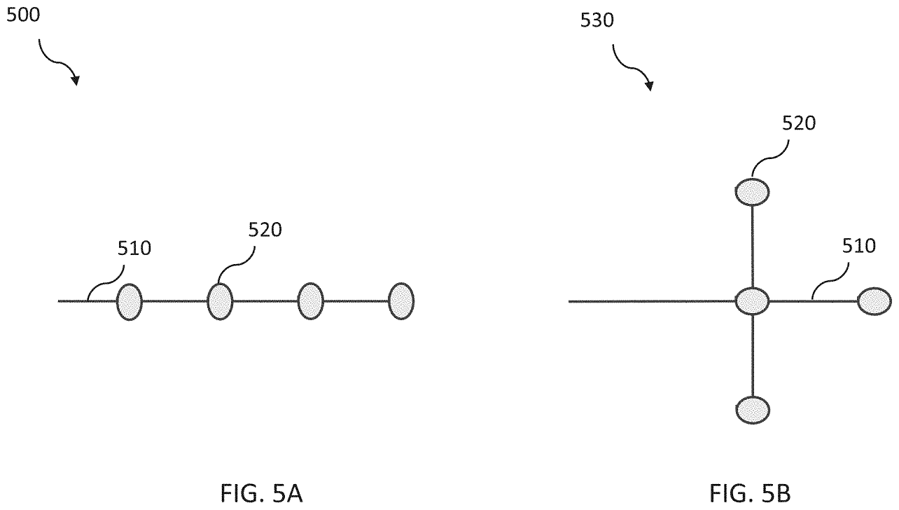

The channels (or groupings of light points 440) can form a variety of configurations, layouts, or geometries. For example, FIG. 5A depicts a channel with a linear configuration of light points 520 (supported by low voltage cables 510), whereas FIG. 5B depicts a channel with a tree configuration. In some cases, the channels utilize low voltage cables 510 having lengths of 8-10 feet. Further, each light point 520 can facilitate connections (via mounting harnesses 430) to one, two, or three other light points (e.g., as shown in FIG. 5B). Thus, the modularity of the system 400 enables various differently configured layouts or deployments of light points 520 within a space.

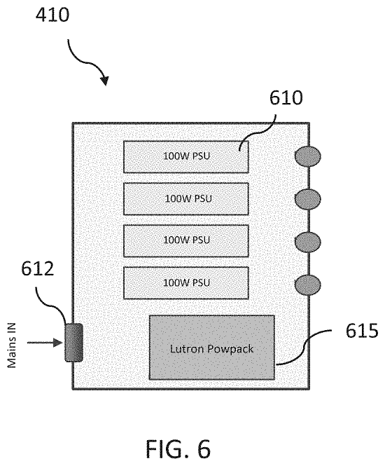

The limited voltage power box 410, as described herein, includes components to drive or supply power, at a low voltage, to four channels of light fixtures. FIG. 6 is a block diagram illustrating example components of the box 410. The box 410 includes four power supply units 610 (e.g., 100 W PSUs), each supplying power to a channel via Power over Ethernet (PoE) connectors (e.g., IEEE 802.3bt-Type 4 PoE++), a connection 612 to a MAINS power supply, and a power pack 615 (e.g., a Lutron Power Pack).

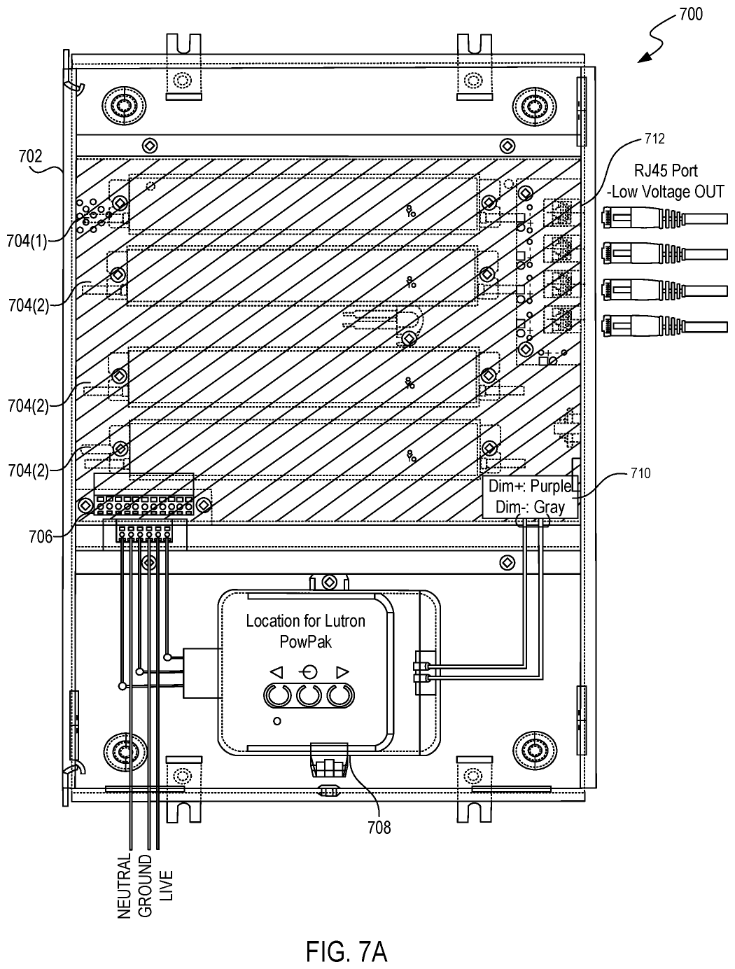

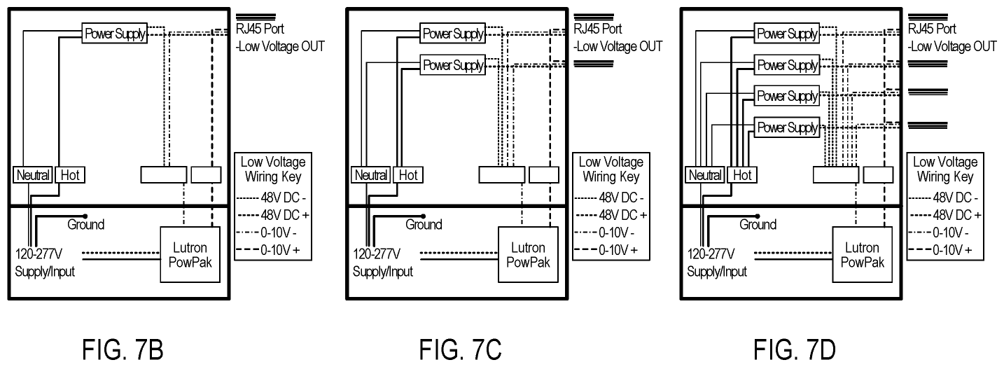

FIGS. 7A to 7D depict additional details of various example low voltage equipment assemblies of the limited voltage power box 410. For example, FIG. 7A illustrates a limited voltage power box 700 including an electrical enclosure 702. The enclosure 702 can house e.g., four 48V power supplies 704(1)-704(4) and a wireless control component 708 (e.g., Lutron Power Pak). The wireless control component 708 can receive signals from a wireless device, such as a wireless wall switch, for example, to control the lighting. A mains terminal block 706 distributes line voltage to each power supply 704 and a control terminal block 710 distributes control signals (e.g., 0-10 Volt) from the Power Pak 708 to each RJ45 port 712. In some implementations, the control terminal block 710 can be divided to separately connect the −48V and −0-10V, as shown in FIGS. 7B to 7D. FIGS. 7B to 7D depict a power box with 1, 2, and 4 PSUs for use in powering 1, 2, and 4 channels of light fixtures, respectively. The wiring configuration disclosed herein provides a unique advantage for modular/configurable lighting systems in that the voltage provided to the light modules or fixtures is NEC Class 2. Therefore, an office worker can unplug and plug-in the disclosed fixtures in any desired configuration without requiring the assistance of an electrician, which would be required if the lighting was powered via typical Class 1 wiring.

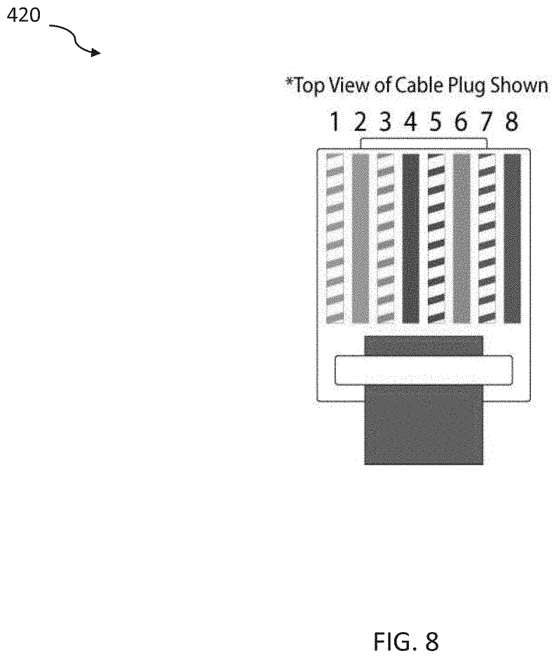

As described herein, the low voltage cables 420 or 510 can be CAT 6 cables or other Power over Ethernet cables. In some cases, the cables have lengths of 8 to 10 feet, and loop resistances of 12.5 Ohms or greater. FIG. 8 depicts an example cable (and plug) 420 and its associated industry standard wiring.

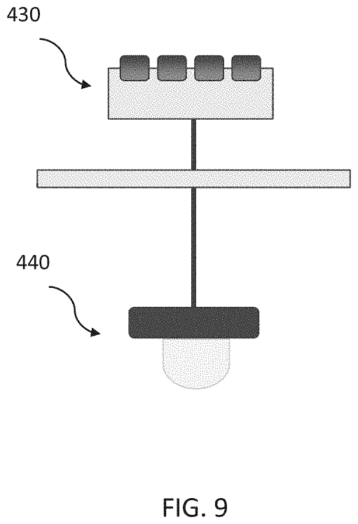

The light modules 440 described herein connect to the box 410 or other light modules via the cables 420 (often via the mounting harness 430), see FIG. 4. FIG. 9 is a block diagram illustrating the light module 440 and associated mounting harness 430. As shown, the mounting harness 430 is deployed within the ceiling of a space, and connects to the light module 440, which extends into a space to illuminate the space.

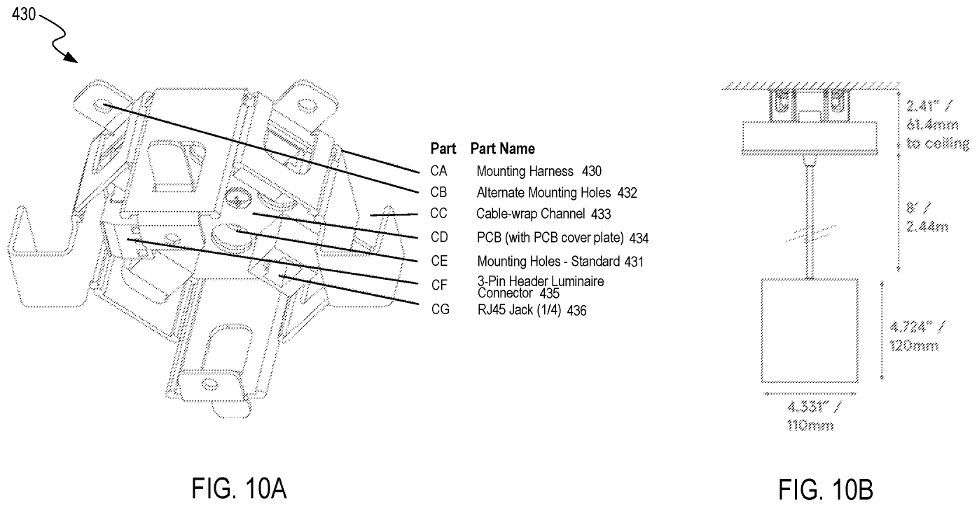

The mounting harness 430 can include quick connect components, such as a four- or five-way splitter, which facilitates easy connections between light modules 440 and the box 410. FIGS. 10A to 10B are diagrams illustrating various configurations of the lighting harness. The harness 430 can comprise a folded metal bracket which includes several mounting holes, both standard 431 and alternate 432. The harness 430 can carry four RJ45 jacks 436 wired in parallel via a printed circuit board (PCB) 434. Three of the jacks 436 are facing outward (e.g., horizontally) while one is facing downward (e.g., vertically). The PCB 434 also includes a 3-pin Luminaire connector 435 to provide power to a light module 440 carried by the harness 430. In some implementations, the harness 430 can include hook portions to provide channels 433 configured to support excess cable that may be wrapped around the harness 430. The downward facing jack 436 can be connected to a limited voltage power box 410/700 and the outward facing jacks 436 can be connected to additional light modules 440 to create the configurations shown in FIGS. 5A and 5B, for example.

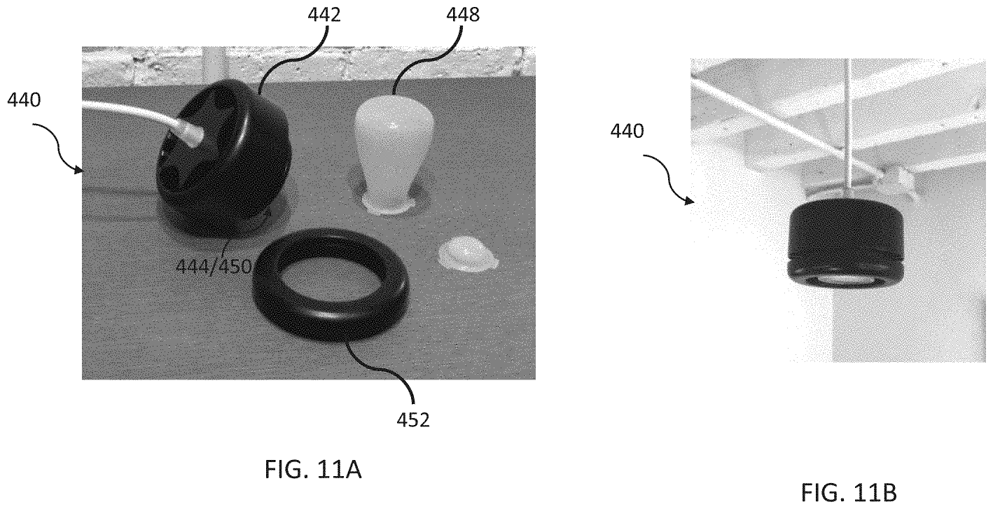

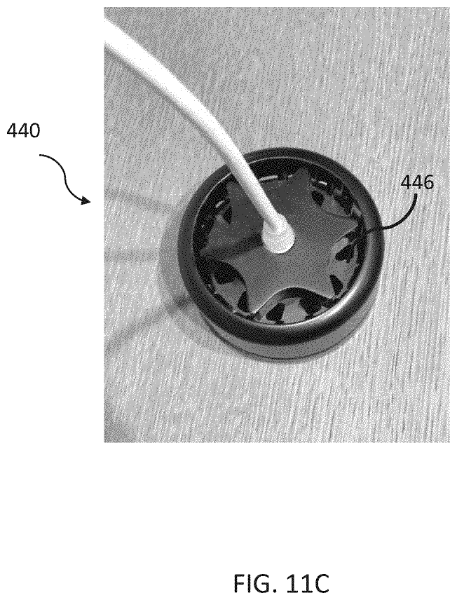

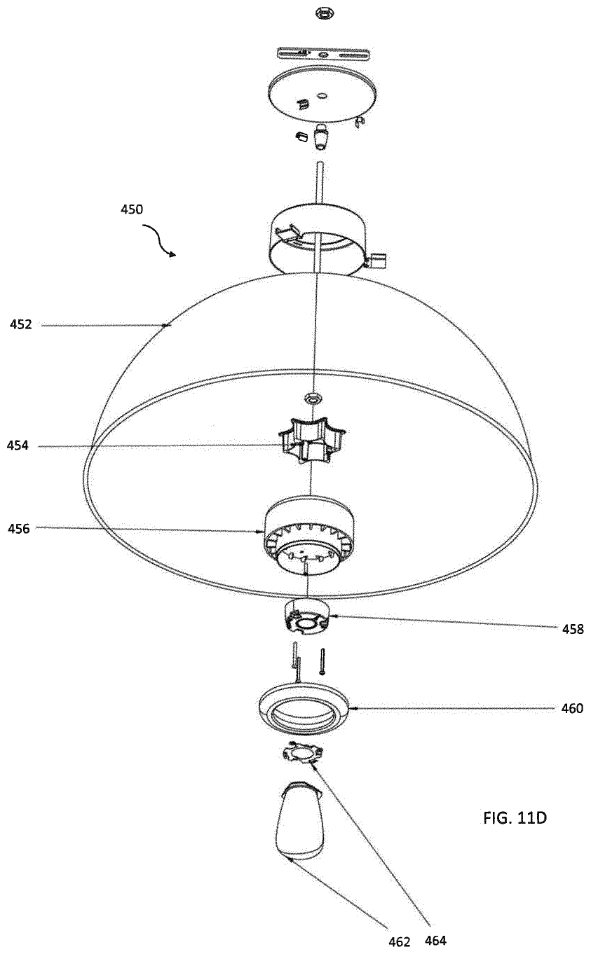

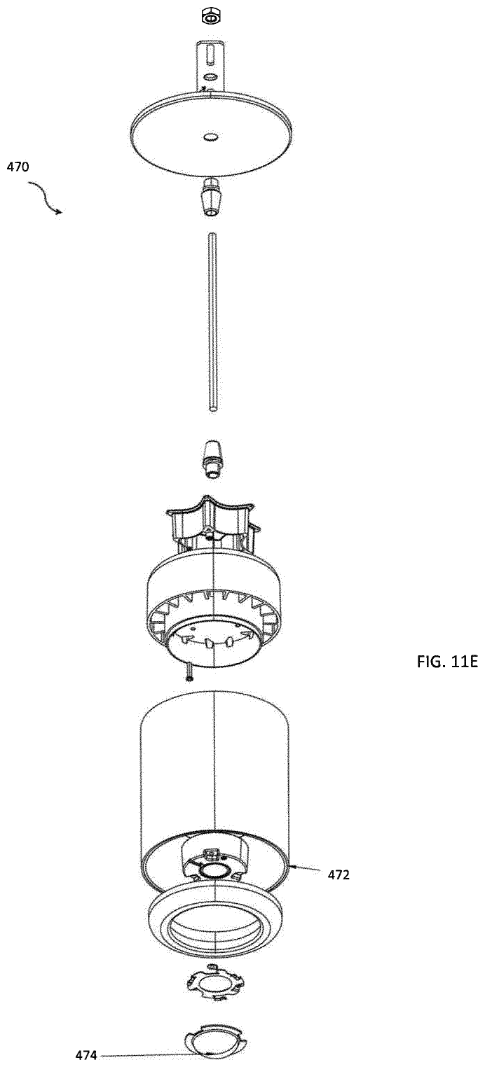

As described herein, the light module 440 is an assembly of modular components, including a heat sink, diffuser, LED bulb, and/or communication component. FIGS. 11A to 11C are diagrams illustrating example components of the light module 440. For example, the light module 440 can include an internal BLE component or radio (or other communication components, such as wireless or near-field components that facilitate wireless or RF control) that communicate with other networked components and facilitate the operation or modification of the light fixture 440. The light fixture 440, then, provides high quality, modifiable lighting (e.g., dimming functions) without flickering.

For example, the light module or fixture 440 can include a housing 442 and an LED module 444 (not visible) that provides illumination to a space and is contained within the housing 442. A heat sink module 446 (FIG. 11C) can connect to the LED module 444 and can be contained within the housing 442. A base plate 450 (not visible) is connected to the LED module 444 within the housing 442. Alternative optics 448 can be connected to the base plate. The heat sink module 446 can also include the BLE component or other communication components. Further, the heat sink module 446 can have a shape (e.g., a star shape), that facilitates the screwing/unscrewing of the base plate 450 when removing components from the assembly. In some implementations, the housing 442 can include an accessory ring 452 that threads to the housing 442. Various shades can snap to the accessory ring 452.

In some embodiments, each of the fixtures 440 are part of a network of addressable fixtures and integrated with other systems of a workspace. Thus, in such cases, the lighting system 400 can modify how it illuminates a space based on user or member preferences, can track or monitor energy use, can provide data regarding operation of the fixtures, can signal or provide guidance to members of a space, and so on.

As shown in FIG. 11D a light module 450 can include a bowl shaped shade 452 carried by a heat sink module 456 coupled with a star shaped retainer 454. An LED module 458 attaches to the heat sink module 456 with three machine screws that extend through a lens retainer 464, the LED module 458, the heat sink 456 and thread into retainer 454. A diffuser lens 462 attaches to the lens retainer 464 with a partial turn of the lens. In the depicted embodiment, the diffuser lens 462 is bulb shaped. In some implementations, an accessory ring 460 can attach to the heat sink 456. In another representative embodiment, light module 470 has a similar constructions as that described above with respect to FIG. 11D. Light module 470 includes a can shaped shade 472 and a low profile diffuser lens 474.

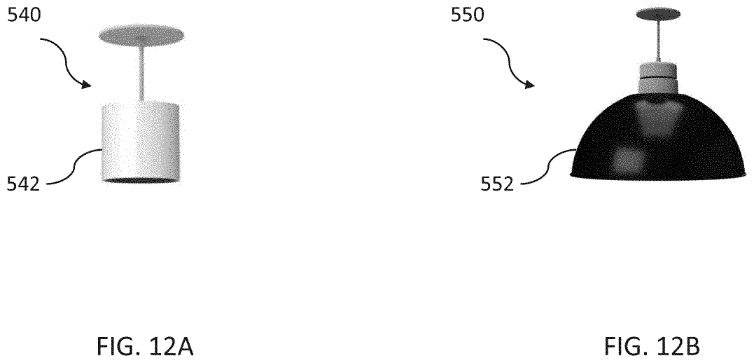

As described herein, the modularity of the disclosed light fixtures facilitates the changing or modification of the design or appearance of the fixture (and thus an entire area of fixtures). FIGS. 12A to 12B are diagrams illustrating example designs of light fixtures based on a simple change of the diffuser or shade of the fixtures 440. For example, fixture 540 includes a barrel or can shaped diffuser 542 and fixture 550 includes a semi-spherical or bowl shaped diffuser 552.

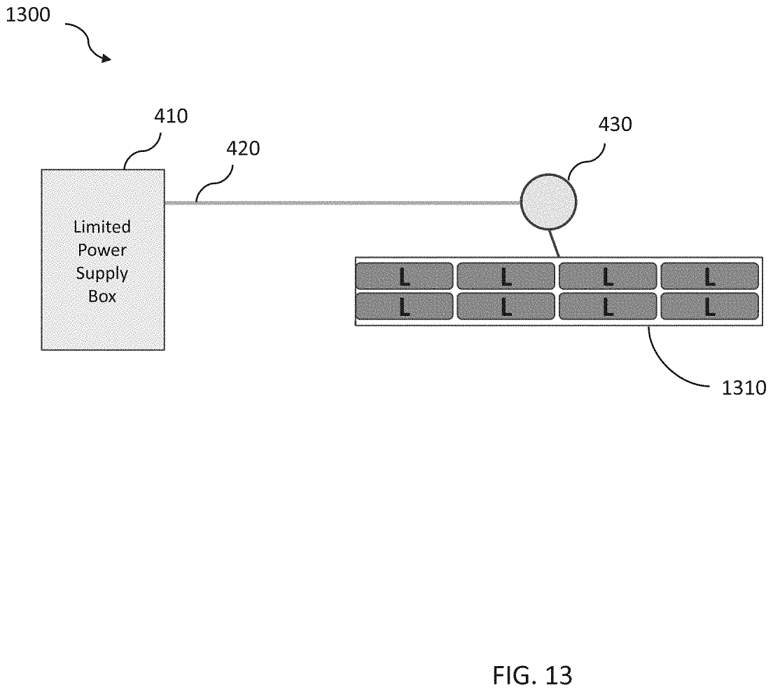

In addition to channels of stand-alone light fixtures, the low voltage lighting system 400 described herein can also power linear lighting systems. FIG. 13 is a block diagram illustrating example components of a low voltage linear lighting system 1300. The linear system 1300 includes a light module assembly 1310 connected to the limited voltage power box 410 via the low voltage cable 420 and the mounting harness 430.

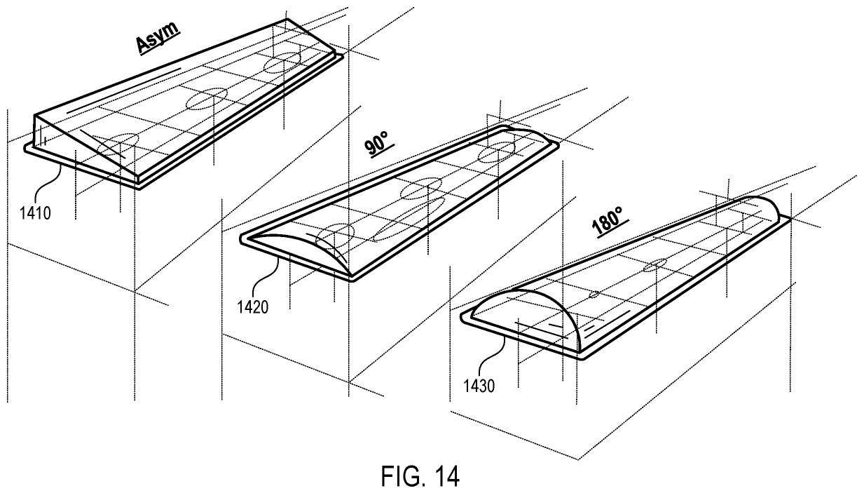

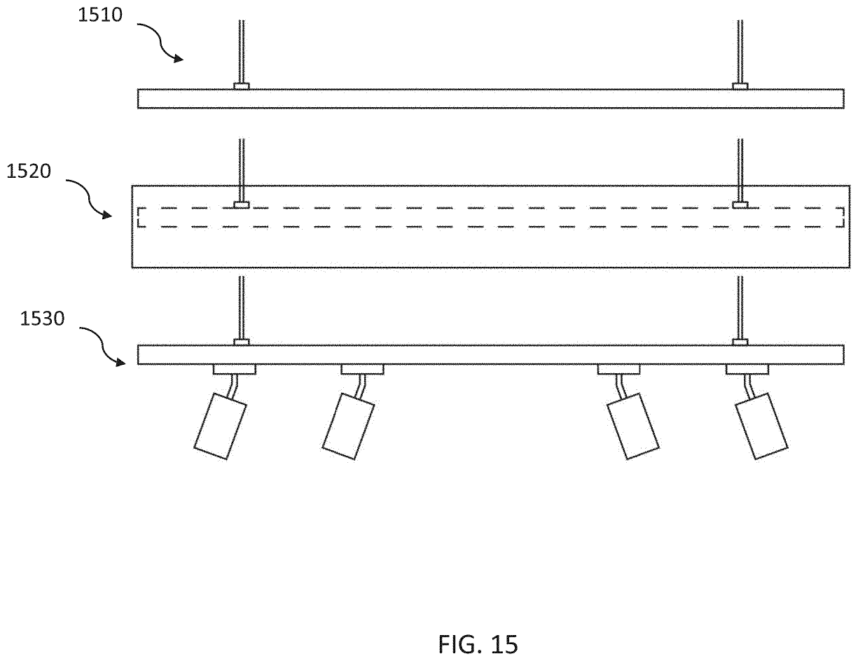

The light module assembly 1310 includes, for example, eight 10 W light modules arranged on a light track (e.g., a 2.4 meter light track). The light modules, in some cases, are 2 feet in length, can be configured with a variety of optics or formats, and provide 750 lumens at 10 Watts. For example, FIG. 14 depicts example fixture format designs for the light modules. Lens 1410 can comprise an asymmetric shape relative to a longitudinal center line of the lens. Lens 1420 can comprise a 90 degree arc section of a cylinder and lens 1430 can comprise a 180 degree arc section of a cylinder to provide varying light dispersion effects.

Different configurations or applications of track or other linear lighting can employ some or all aspects of the low voltage linear lighting system 1300. FIG. 15 is a diagram illustrating various applications of the linear lighting system 1300. For example, a standard LV module 1510, a diffused shade assembly 1520, or a track-lighting application 1530 can employ the low voltage components described herein.

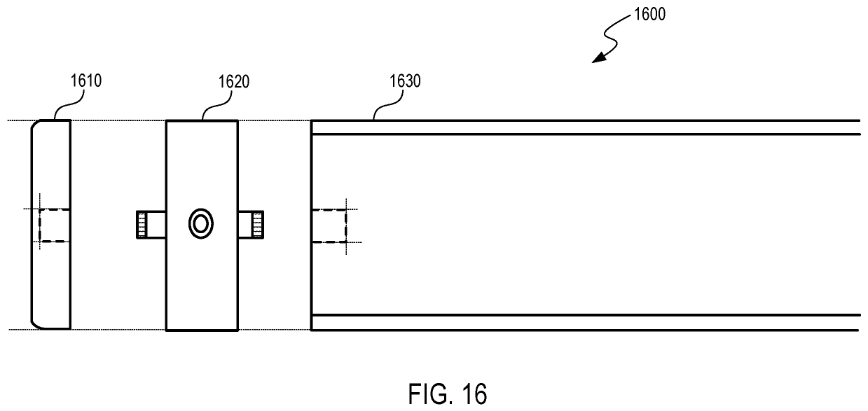

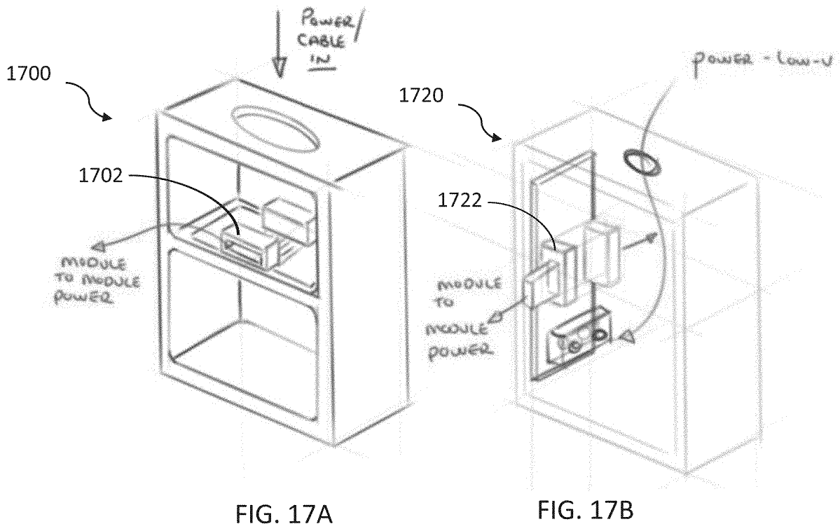

The modularity of the system 1300 can extend to the deployment of power connections within the system. FIG. 16 is a diagram illustrating an example power connection architecture 1600 for the linear lighting system. Extrusion framework 1630 connects to a power module 1620 (or extender), which utilizes an end cap 1610 at the end of a connection or channel. FIGS. 17A to 17B provide additional architectures of power modules (including module-to-module power connections). FIG. 17A illustrates a module 1700 including horizontally oriented female module-to-module connectors 1702 and an opening in the top to receive a power supply cable (now shown). FIG. 17B illustrates a module 1720 including vertically oriented male module-to-module connectors 1722 and an opening in the top to receive a power supply cable (now shown).

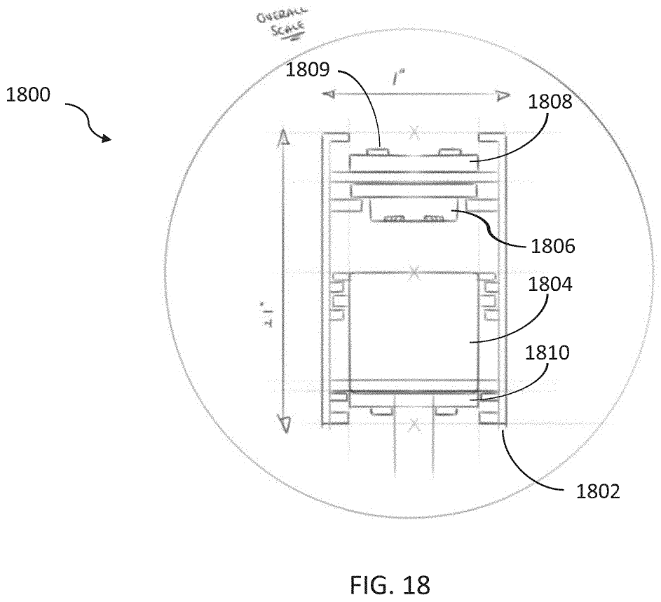

Further, FIG. 18 depicts a complete linear lighting system assembly 1800, where all components are integrated into one extrusion 1802. The extrusion 1802 carries an intelligent driver module 1804 that powers and controls top and bottom LED boards 1808 and 1810, respectively. Each LED board 1808 and 1810 can include multiple LEDs 1809. In some implementations, the extrusion 1802 can carry a bus board 1806 for powering the various LEDs positioned along the assembly 1800.

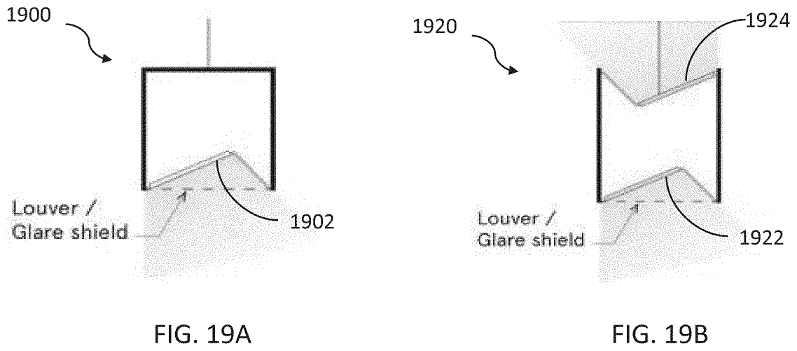

As described herein, various lighting types can employ the linear lighting system 1300. FIGS. 19A to 19B depict a few examples, such as lighting having one or two illuminated areas. Fixture 1900 includes an angled louver or glare shield 1902 positioned on the bottom of the fixture to provide downward lighting. Fixture 1920 includes an angled louver or glare shield 1922 positioned on the bottom of the fixture and an oppositely oriented louver 1924 positioned on the top of the fixture to provide diffuse lighting that reflects off of the surface of a ceiling. Other types include wash lighting, track lighting, suspended track lighting, office lighting, millwork lighting, and so on.

Thus, as described herein, the low voltage lighting system described herein provides for various configurations of illumination within a workspace or other area, while utilizing low voltage and/or digitally addressable light fixtures. Although specific embodiments of, and examples for, the technology are described above for illustrative purposes, various embodiments are possible within the scope of the technology. For example, a lighting system in accordance with embodiments of the present technology can comprise a low voltage power box configured to supply power to multiple modular light fixtures, one or more low voltage cables, and a modular light fixture connected to the low voltage power box via the one or more low voltage cables. The low voltage power box can comprise a wireless control component operative to receive signals from a wireless device and control the modular light fixture according to the received signals. In some embodiments, each of the modular light fixtures includes a communication component configured to facilitate control of the modular light fixture via a wireless network. In some embodiments, each of the modular light fixtures is a linear light module assembly of multiple linear light modules. In some embodiments, the low voltage power box supplies power to a channel of four modular light fixtures, each of which are connected to at least one other modular light fixture via one low voltage cable. In some embodiments, the low voltage power box supplies power to four distinct channels of light fixtures, wherein each channel of light fixtures includes four modular light fixtures, each of which are connected to at least one other modular light fixture via one low power cable. In some embodiments, the low voltage power box includes a power supply unit that supplies power to the multiple modular light fixtures using Power over Ethernet (PoE) protocols via the one or more low voltage cables.

A modular lighting fixture configured to be powered by a low voltage power box in accordance with embodiments of the present technology can comprise a housing, an LED module positioned within the housing, a heat sink module connected to the LED module and positioned within the housing, a diffuser positioned to diffuse illumination provided by the LED module, and a base plate that screws into the housing to removably fix the diffuser to the housing. In some embodiments, the heat sink module includes a Bluetooth component configured to exchange data between the modular lighting fixture and a wireless network. In some embodiments, a low voltage cable connects the modular lighting fixture to the low voltage power box.

A lighting system in accordance with embodiments of the present technology can comprise a low voltage power box configured to supply power to multiple modular light fixtures, one or more multi-conductor low voltage cables, and at least one modular light fixture connected to the low voltage power box via the one or more low voltage cables. The low voltage power box can comprise at least one 48 volt power supply and at least one 0-10 volt controller. The low voltage cables are connected to the at least one 48 volt power supply and the at least one 0-10 volt controller. The modular light fixtures can comprise a housing, an LED module positioned within the housing, a heat sink module connected to the LED module and positioned within the housing, a diffuser positioned to diffuse illumination provided by the LED module, and a base plate that screws into the housing to removably fix the diffuser to the housing. In some embodiments, the low voltage power box supplies power to four distinct channels of light fixtures, wherein each channel of light fixtures includes four modular light fixtures, each of which are connected to at least one other modular light fixture via one low power cable. In some embodiments, each of the four distinct channels of light fixtures includes four mounting harnesses, each corresponding to an associated one of the modular light fixtures. In some embodiments, each mounting harness comprises a folded metal bracket carrying four RJ45 jacks and one 3 pin connector, wherein the associated modular light fixture is electrically connected to the 3 pin connector. In some embodiments, each of the four modular light fixtures is connected to at least one other modular light fixture via one low power cable connected to a corresponding RJ45 jack. In some embodiments, each of the modular light fixtures includes a communication component configured to facilitate control of the modular light fixture via a wireless network.

This application is related to U.S. patent application Ser. No. 16/250,983 filed Jan. 17, 2019 having Attorney Docket No. 128135-8002.US01, titled “RESERVATION SYSTEM IN A SHARED WORKSPACE;” U.S. patent application Ser. No. 16/835,095 filed Mar. 30, 2020, having Attorney Docket No. 128135-8015.US01, titled “MODULAR STRUCTURES FOR CREATING FUNCTIONAL SPACES;” U.S. patent application Ser. No. 16/833,278 filed Mar. 27, 2020, having Attorney Docket No. 128135-8016.US01, titled “PROVIDING PHYSICAL SPACES, RESOURCES, AND INFORMATION TO USERS AND MANAGERS WITHIN A WORKSPACE, SUCH AS VIA A MEMBER APP;” U.S. Patent Application No. 63/001,168 filed Mar. 27, 2020 having Attorney Docket No. 128135-8017.US01, titled “DIGITAL PLATFORM FOR WORKSPACE;” U.S. Patent Application No. 63/001,178 filed Mar. 27, 2020, Attorney Docket No. 128135-8018.US01, titled “SPATIAL DATA INSIGHTS AND ANALYTICS;” U.S. patent application Ser. No. 16/835,012 filed Mar. 30, 2020 having Attorney Docket No. 128135-8020.US02, titled “AUTOMATIC OFFICE SPACE LAYOUT;” U.S. patent application Ser. No. 16/863,891 filed Apr. 30, 2020 having Attorney Docket No. 128135-8021.US01, titled “AUTOMATICALLY PROCESSING TICKETS;” U.S. patent application Ser. No. 16/920,149 filed Jul. 2, 2020 having Attorney Docket No. 128135-8050.US01, titled “DEMOUNTABLE MODULAR WALL STRUCTURES,” all of which are herein incorporated by reference in their entireties.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

I/We claim:

1. A lighting system, comprising:
a low voltage power box configured to supply power to multiple modular light fixtures;
one or more low voltage cables; and
a modular light fixture connected to the low voltage power box via the one or more low voltage cables;
wherein the low voltage power box comprises a wireless control component operative to receive signals from a wireless device and control the modular light fixture according to the received signals.

2. The lighting system of claim 1, wherein each of the modular light fixtures includes a communication component configured to facilitate control of the modular light fixture via a wireless network.

3. The lighting system of claim 1, wherein each of the modular light fixtures is a linear light module assembly of multiple linear light modules.

4. The lighting system of claim 1, wherein the low voltage power box supplies power to a channel of four modular light fixtures, each of which are connected to at least one other modular light fixture via one low voltage cable.

5. The lighting system of claim 1, wherein the low voltage power box supplies power to four distinct channels of light fixtures, wherein each channel of light fixtures includes four modular light fixtures, each of which are connected to at least one other modular light fixture via one low power cable.

6. The lighting system of claim 1, wherein the low voltage power box includes a power supply unit that supplies power to the multiple modular light fixtures using Power over Ethernet (PoE) protocols via the one or more low voltage cables.

7. A modular lighting fixture configured to be powered by a low voltage power box, the modular lighting fixture comprising:
a housing;
an LED module positioned within the housing;
a heat sink module connected to the LED module and positioned within the housing;
a diffuser positioned to diffuse illumination provided by the LED module; and
a base plate that screws into the housing to removably fix the diffuser to the housing.

8. The modular lighting fixture of claim 10, wherein the heat sink module includes a Bluetooth component configured to exchange data between the modular lighting fixture and a wireless network.

9. The modular lighting fixture of claim 10, wherein a low voltage cable connects the modular lighting fixture to the low voltage power box.

10. A lighting system, comprising:
a low voltage power box configured to supply power to multiple modular light fixtures,
the low voltage power box, comprising:
at least one 48 volt power supply; and
at least one 0-10 volt controller;
one or more low voltage cables, each connected to the at least one 48 volt power supply and the at least one 0-10 volt controller; and
at least one modular light fixture connected to the low voltage power box via the one or more low voltage cables, each of the at least one modular light fixtures,
comprising:
a housing;
an LED module positioned within the housing;
a heat sink module connected to the LED module and positioned within the housing;
a diffuser positioned to diffuse illumination provided by the LED module; and
a base plate that screws into the housing to removably fix the diffuser to the housing.

11. The lighting system of claim 10, wherein the low voltage power box supplies power to four distinct channels of light fixtures, wherein each channel of light fixtures includes four modular light fixtures, each of which are connected to at least one other modular light fixture via one low power cable.

12. The lighting system of claim 11, wherein each of the four distinct channels of light fixtures includes four mounting harnesses, each corresponding to an associated one of the modular light fixtures.

13. The lighting system of claim 12, wherein each mounting harness comprises a folded metal bracket carrying four RJ45 jacks and one 3 pin connector, wherein the associated modular light fixture is electrically connected to the 3 pin connector.

14. The lighting system of claim 13, wherein each of the four modular light fixtures is connected to at least one other modular light fixture via one low power cable connected to a corresponding RJ45 jack.

15. The lighting system of claim 10, wherein each of the modular light fixtures includes a communication component configured to facilitate control of the modular light fixture via a wireless network.
